(19) United States
(12) Patent Application Publication
(10) Pub. No.: US 2024/0098107 A1
(43) Pub. Date: Mar. 21, 2024

(54) SYSTEM AND METHOD FOR MONITORING A COMPUTER RESOURCE ASSET USING A SMART CONTRACT AND A NEURAL NETWORK

(71) Applicant: Saudi Arabian Oil Company, Dhahran (SA)

(72) Inventors: Johara Abdulrahman AL Jarri, Dammam (SA); Mohammed A. Alfraih, Dhahran (SA)

(21) Appl. No.: 17/933,614

(22) Filed: Sep. 20, 2022

(51) Int. Cl. H04L 9/40

(52) U.S. Cl. CPC H04L 63/1433

(57) ABSTRACT

A system and method monitor a computer resource asset for vulnerability and security weaknesses using a smart contract and a neural network. The system comprises a processor configured to receive data from a data source, a memory configured to store current smart contract baseline data, an artificial neural network including a plurality of nodes configured as a plurality of layers to determine a new data feed in the received data and to update the current smart contract baseline data, a smart contract monitoring subsystem configured to monitor a computer resource asset using the current smart contract baseline data, and a remediation subsystem configured to remediate access of the computer resource asset to a computer network. The method implements the system.

### FIELD OF THE DISCLOSURE

The present disclosure relates generally to monitoring a computer resource asset for security concerns, and, more particularly, to a system and method for monitoring a computer resource asset for vulnerability and security weaknesses using a smart contract and a neural network.

### BACKGROUND OF THE DISCLOSURE

Cybersecurity is a paramount concern for any enterprise with multiple computer resource assets. The increased connectivity and addition of many computer resource assets in a network increases the need to monitor the cybersecurity among the computer resource assets. One method of monitoring involves regular checks of each computer resource asset upon connection to the network. However, such regular checks are complicated to perform due to changing cybersecurity intelligence of malware, changing organization standards, and new vulnerability results.

### SUMMARY OF THE DISCLOSURE

According to an embodiment consistent with the present disclosure, a system and method monitor a computer resource asset for vulnerability and security weaknesses using a smart contract and a neural network.

In an embodiment, a system comprises a processor, a memory, an artificial neural network, a smart contract monitoring subsystem, and a remediation subsystem. The processor is configured to receive data from a data source. The memory is in communication with the processor and stores instructions that, when executed by the processor, are configured to store current smart contract baseline data. The artificial neural network includes a plurality of nodes configured as a plurality of layers to determine a new data feed in the received data, and to update the current smart contract baseline data. The smart contract monitoring subsystem is configured to monitor a computer resource asset using the current smart contract baseline data. The remediation subsystem is configured to remediate access of the computer resource asset to a computer network.

The memory stores the current smart contract baseline data in a blockchain. The remediation subsystem remediates the access by automatically disconnecting the computer resource asset from the computer network. Alternatively, an output device is configured to output information to a user, remediation subsystem remediates the access by generating an alert as the outputted information, and the user disconnects the computer resource asset from the computer network. The data source includes: an intelligence source, an organization standard, a vulnerability result, the training data, and initial smart contract baseline data. The artificial neural network is trained by training data to determine the new data feed in the received data, and to update the current smart contract baseline data from the new data feed. The smart contract monitoring subsystem determines a vulnerability or a security configuration weakness of the computer resource asset. The remediation subsystem, responsive to the determined vulnerability or a security configuration weakness, remediates the access of the computer resource asset to the computer network.

In another embodiment, a method comprises receiving data from a data source, storing current smart contract baseline data in a memory, determining a new data feed in the received data using an artificial neural network, updating the current smart contract baseline data using the artificial neural network, monitoring a computer resource asset using the current smart contract baseline data, and remediating access of the computer resource asset to a computer network. The memory stores the current smart contract baseline data in a blockchain. Remediating the access includes automatically disconnecting the computer resource asset from the computer network. Alternatively, an output device is configured to output information to a user, wherein remediating the access includes: generating an alert as the outputted information, and disconnecting, by the user, the computer resource asset from the computer network.

The artificial neural network is trained by training data, wherein the trained artificial neural network determines the new data feed in the received data, and updates the current smart contract baseline data from the new data feed. The monitoring includes determining a vulnerability or a security configuration weakness of the computer resource asset. The remediating of the access of the computer resource asset to the computer network is responsive to the determined vulnerability or a security configuration weakness.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system, according to an embodiment.

FIG. 2 is a schematic of a data source of the system of FIG. 1.

FIG. 3 is a flowchart of a method of operation of the system of FIG. 1.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 10 and method 300 for monitoring a computer resource asset for vulnerability and security weaknesses using a smart contract and a neural network.

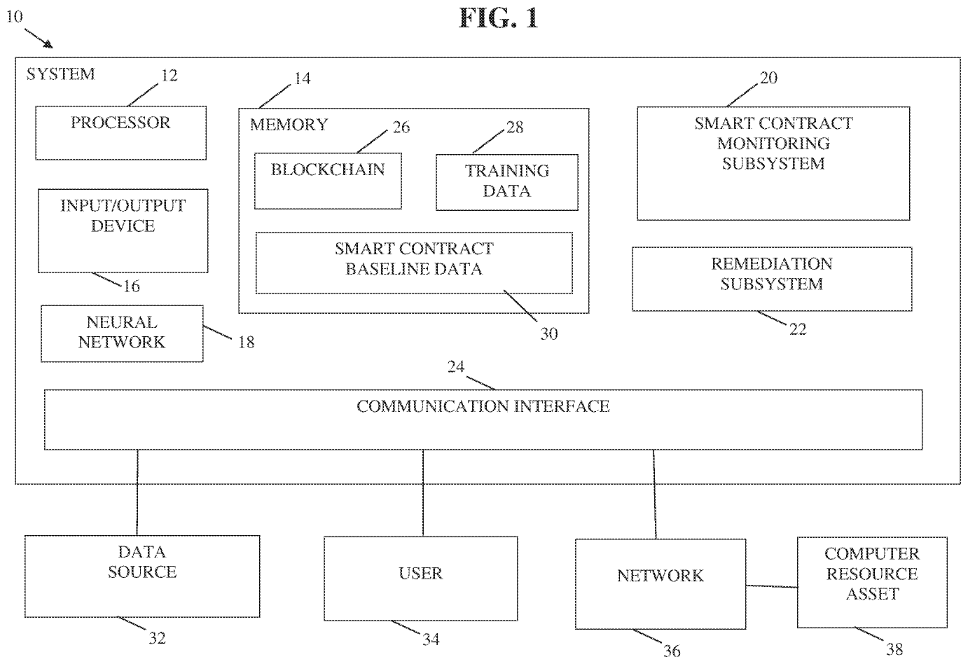

As shown in FIG. 1, the system 10 includes a processor 12, a memory 14, an input/output device 16, an artificial neural network 18, a smart contract monitoring subsystem 20, a remediation subsystem 22, and a communication interface 24. The processor 12 can be any known hardware having instructions which, when executed, configure the processor 12 to perform the operations described below. The processor 12 can include a microprocessor. The processor 12 can include internal memory configured to store the instructions.

The memory 14 can be any known hardware configured to store data. The memory 14 includes a blockchain 26, training data 28, and smart contract baseline data 30. The blockchain 26 is a plurality of blocks of data. The blockchain 26 acts as a ledger that provides a history or record of all previous actions by the smart contract monitoring subsystem 20. The blockchain 26 is immutable due to a unique cryptographic security protocol that the blockchain 26 employs. The training data 28 is a plurality of historical vulnerability instances and known security configuration weaknesses. The artificial neural network 18 is trained using the training data 28, as described below. The smart contract baseline data 30 is a current set of data utilized by the smart contract monitoring subsystem 20 to monitor a computer resource asset 38 for vulnerabilities and security configuration weaknesses. The smart contract baseline data 30 can include an operating system (OS) version number, a list of the latest software patches, and a list of secure protocols. The computer resource asset 38 can be a software application, a device, a system, or another network connected to or having access to the network 36.

The input/output device 16 can be any known hardware storing instructions which, when executed, allow the user 34 to interact with the system 10. The input/output device 16 can include a keyboard, a keypad, a mouse, and a display. The display can be a touchscreen. The input/output device 16 can display a graphic user interface (GUI) to the user 34. Using the input/output device 16, the user can control the system 10. For example, as described below, upon detection of a vulnerability or a security weakness by the smart contract monitoring subsystem 20, the user can receive information such as an alert through the input/output device 16. The user can then control the system 10 to, in turn, control the access of the computer resource asset 38 to a network 36.

The artificial neural network 18 includes a plurality of nodes or neurons arranged in a plurality of layers, with connections between the nodes and the layers. Upon training of the artificial neural network 18 by the training data 28, the artificial neural network 18 has the connections between nodes and layers strengthened or weakened. Thus, the training configures the artificial neural network 18 to perform specific operations, such as classification of newly received data, as described below.

The smart contract monitoring subsystem 20 regularly monitors a cybersecurity data feed from a data source 32 with regard to a computer resource asset 38. The smart contract monitoring subsystem 20 compares the cybersecurity data feed against the current smart contract baseline data 30 to perform an action, such as generating an alert of a vulnerability or a security weakness of the computer resource asset 38. The remediation subsystem 22 reacts to an action by the smart contract monitoring subsystem 20. For example, the remediation subsystem 22 can react to the alert by controlling access of the computer resource asset 38 to the network 36. Such controlling of access can include disconnecting the computer resource asset 38 from the network 36.

The communication interface 24 can be any known hardware configured to mediate communications between components of the system 10 and the data source 32, the user 34, the network 36, and the computer resource asset 38. The communication interface 24 can include a processor having instructions which, when executed, implement a known communication protocol depending on the devices or elements 32-38 interacting with the system 10. For example, the communication interface 24 can communicate signals representing data between the user 34 and the input/output device 16.

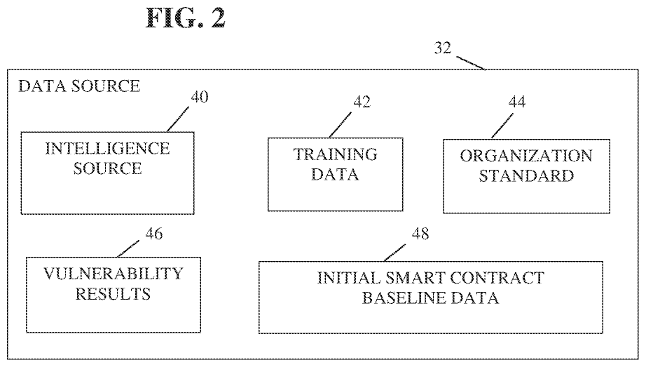

Referring to FIG. 2, the data source 32 can include an intelligence source 40, training data 42, an organization standard 44, vulnerability results 46, and initial smart contract baseline data 48. The intelligence source 40 can include data regarding cybersecurity threats. For example, the intelligence source 40 can be the SANS Internet Storm Center, a database of known malware and computer viruses, and news alerts regarding cybersecurity issues. The training data 42 can be an up-to-date plurality of historical vulnerability instances and known security configuration weaknesses. The training data 28 in the memory 14 can be a copy of the training data 42. For example, at regular intervals, the system 10 can update the training data 28 from the up-to-date training data 42. The organization standard 44 can be a cybersecurity standard associated with the U.S. National Vulnerability Database (NVD, the U.S. National Institute of Standards and Technology (NIST), the U.S. Department of Defense (DoD), a benchmark associated with the Center for Internet Security (CIS), the Payment Card Industry Data Security Standard (PCI DSS), or any known organization-based cybersecurity standard.

The vulnerability results 46 are historical results of previous or current evaluations of cybersecurity vulnerabilities performed by the smart contract monitoring subsystem 20. For example, as described herein, upon the smart contract monitoring subsystem 20 determining that the computer resource asset 38 has a vulnerability or a security configuration weakness, such a vulnerability or weakness can be communicated to the data source 32 through the communication interface 24 to update the vulnerability results 46. The initial smart contract baseline data 48 can be an original set of minimum major requirements or conditions from cybersecurity sources such as encryption algorithms, authentication mechanisms, security standards, etc. The smart contract baseline data 30 can be an initial copy of the initial smart contract baseline data 48, with the system 10 updating the smart contract baseline data 30 based on current data from the data source 32, as described below. In addition, the smart contract baseline data 30 can be updated based on the relevance of the discovery of a vulnerability or security configuration weakness to the existing infrastructure of the network 36. The smart contract baseline data 30 can also be updated based on which computer resource assets 38 are connected to or removed from the network 36. When the smart contract monitoring subsystem 20 determines that the smart conditions are met, the smart contract monitoring subsystem 20 generates an action, such as an alert described above.

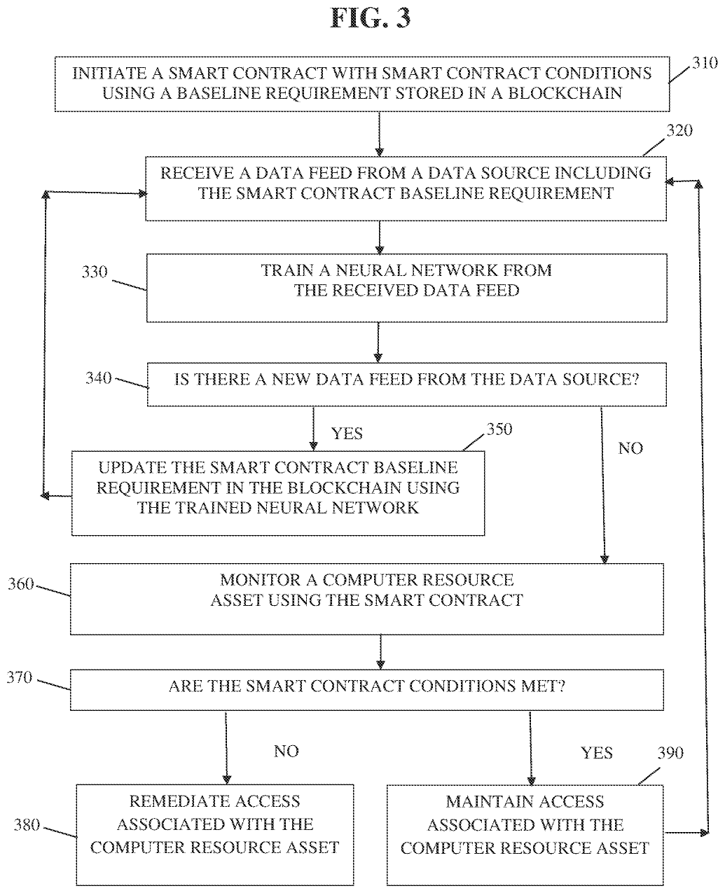

Referring to FIG. 3, the method 300 includes initiating a smart contract with smart contract conditions using a baseline requirement from the initial smart contract baseline data 48 in step 310. In step 310, the baseline requirement constitutes the current smart contract baseline data 30. The baseline requirement is stored in the blockchain 26 in step 310. The method 300 then receives a data feed from the data source 32 including the smart contract baseline requirement in step 320. As described above, the data source 32 includes the initial training data 42. The method 300 then trains the artificial neural network 18 from the received data feed, including the initial training data in step 330.

The method 300 then checks whether there is a new data feed from the data source in step 340 using the trained artificial neural network 18. The trained artificial neural network 18 classifies the data feed as old or new. For example, if the vulnerability results 46 have a new addition based on a scanning or monitoring of the computer resource asset 38 for vulnerability, the trained artificial neural network 18 classifies the additional vulnerability result as new. If there is a new data feed in step 340, the method 300 updates the smart contract basement requirement in the blockchain 26 using the trained artificial neural network 18 in step 350. In particular, the new data feed, classified by the trained artificial neural network 18, is provided to the memory 14 to update the smart contract baseline data 30, which is also stored in the immutable blockchain 26. The use of the blockchain 26 provides a secure backup of the smart contract baseline data 30 in the event that the smart contract baseline data 30 is corrupted or otherwise compromised.

The method 300 then loops back to step 320 receive the data feed from the data source 32. However, in step 340, if there is no new data feed, the method 300 monitors the computer resource asset 38 using the smart contract in step 360. In particular, the smart contract monitoring subsystem 20 uses the current smart contract baseline data 30 in the memory 14 to evaluate the vulnerability or any security configuration weakness of the computer resource asset 38. The method 300 then proceeds to step 370.

In step 370, if the smart contract conditions are not met, there is a vulnerability or a security configuration weakness of the computer resource asset 38, so the system 10 remediates access associated with the computer resource asset 38 in step 380 using the remediation subsystem 22. As described above, the remediation of access can include automatically disconnecting the computer resource asset 38 from the network 36. Alternatively, the remediation of access can include generating an alert which is communicated to the user 34 through the input/output device 16 communicating through the communication interface 24. The user 34 can be a system administrator, who can then manually disconnect the computer resource asset 38 from the network 36.

Otherwise, in step 370, if the smart contract conditions are met, the system 10 maintains the access associated with the computer resource asset 38 in step 390. For example, the access can include further communication between the network 36 and the computer resource asset 38. After step 390, the method 300 loops back to perform steps 320-390.

Accordingly, using the smart contract implemented by the smart contract monitoring subsystem 20, the system 10 and method 300 can constantly check the status of computer resource assets 38 which are part of a network 36. Since the smart contract conditions, defined by the current smart contract baseline data 30, are stored in the immutable blockchain 26, the smart contract is up-to-date on cybersecurity intelligence 40, organization standards 44, and vulnerability results 46.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system, comprising:
a processor configured to receive data from a data source;
a memory in communication with the processor and storing instructions that, when executed by the processor, are configured to store current smart contract baseline data;
an artificial neural network including a plurality of nodes configured as a plurality of layers to determine a new data feed in the received data, and to update the current smart contract baseline data;
a smart contract monitoring subsystem configured to monitor a computer resource asset using the current smart contract baseline data; and
a remediation subsystem configured to remediate access of the computer resource asset to a computer network.

2. The system of claim 1, wherein the memory stores the current smart contract baseline data in a blockchain.

3. The system of claim 1, wherein remediation subsystem remediates the access by automatically disconnecting the computer resource asset from the computer network.

4. The system of claim 1, further comprising:
an output device configured to output information to a user,
wherein remediation subsystem remediates the access by generating an alert as the outputted information, and
wherein the user disconnects the computer resource asset from the computer network.

5. The system of claim 1, wherein the data source includes:
an intelligence source;
an organization standard;
a vulnerability result;
the training data; and
initial smart contract baseline data.

6. The system of claim 1, wherein the artificial neural network is trained by training data to determine the new data feed in the received data, and to update the current smart contract baseline data from the new data feed.

7. The system of claim 1, wherein the smart contract monitoring subsystem determines a vulnerability or a security configuration weakness of the computer resource asset.

8. The system of claim 7, wherein the remediation subsystem, responsive to the determined vulnerability or a security configuration weakness, remediates the access of the computer resource asset to the computer network.

9. A method, comprising:
receiving data from a data source;
storing current smart contract baseline data in a memory;
determining a new data feed in the received data using an artificial neural network;
updating the current smart contract baseline data using the artificial neural network;
monitoring a computer resource asset using the current smart contract baseline data; and
remediating access of the computer resource asset to a computer network.

10. The method of claim 9, wherein the memory stores the current smart contract baseline data in a blockchain.

11. The method of claim 9, wherein remediating the access includes automatically disconnecting the computer resource asset from the computer network.

12. The method of claim 9, further comprising:
providing an output device configured to output information to a user,
wherein remediating the access includes:
generating an alert as the outputted information, and
disconnecting, by the user, the computer resource asset from the computer network.

13. The method of claim 9, further comprising:
training the artificial neural network by training data;
wherein the trained artificial neural network determines the new data feed in the received data, and updates the current smart contract baseline data from the new data feed.

14. The method of claim 9, wherein the monitoring includes determining a vulnerability or a security configuration weakness of the computer resource asset.

15. The method of claim 14, wherein remediating the access of the computer resource asset to the computer network is responsive to the determined vulnerability or a security configuration weakness.
